(19) United States
(12) Patent Application Publication
(10) Pub. No.: US 2022/0378217 A1
(43) Pub. Date: Dec. 1, 2022

(54) AUTO-INFLATING CUSHION STRUCTURE CAPABLE OF BEING COMPRESSED

(71) Applicant: Tsung Hsi LIU, Yilan County (TW)

(72) Inventor: Tsung Hsi LIU, Yilan County (TW)

(21) Appl. No.: 17/330,021

(22) Filed: May 25, 2021

(51) Int. Cl. A47C 27/08; A47G 9/10

(52) U.S. Cl. CPC A47C 27/084; A47C 27/088; A47G 9/1027; A47G 2009/1018

(57) ABSTRACT

An auto-inflating cushion structure includes an outer covering and an inner filling body. The inner filling body is accommodated in the outer covering and has a three-dimensional shape in a normal state. The outer covering is provided with an air valve unit. When not in use, the cushion can be compressed to become thin, thereby reducing the volume without occupying space. When in use, the external air flows into the outer covering, in cooperation with the expansion of the inner filling body, so that the interior of the cushion is automatically inflated. The cushion can serve as an auxiliary support for a user lying on his/her side. In particular, the storage is quite space-saving and the cushion is practical.

### FIELD OF THE INVENTION

The present invention relates to a cushion structure, and more particularly to an auto-inflating cushion structure capable of being compressed, serving as an auxiliary support for a user lying on his/her side.

### BACKGROUND OF THE INVENTION

For many patients who have been bedridden for a long time, they are unable to turn over or move around on their own due to old age or illness. If a patient keeps lying on his/her back for a long time, the muscles and skin on the back are very likely to have bedsores due to the pressure for a long time. Therefore, the caregiver has to turn the patient to lie on his/her left and right side regularly. Sometimes, several pillows are placed behind the patient's back and buttocks to maintain the user lying on the left/right side to relieve the pressure on the skin in turn. Generally, pillows are not small in size. When not in use, pillows take up a lot of space. This is troublesome. Besides, the structure and shape of a pillow are originally designed to provide a support for the user's head. When pillows are used as an auxiliary support to maintain the user lying on the left/right side, it is necessary to frequently adjust the number, position and shape of the pillows to obtain the required supporting effect, which is quite inconvenient. More and more pillows are not made of cotton or down. If the pillow is made of foamed cotton or latex material, the thickness is insufficient and the shape cannot be adjusted, so it is not suitable to serve as a side support for the user.

Accordingly, the inventor of the present invention has devoted himself based on his many years of practical experiences to solve these problems.

### SUMMARY OF THE INVENTION

The primary object of the present invention is to overcome the above-mentioned shortcomings of the prior art and to provide an auto-inflating cushion structure capable of being compressed. When not in use, the cushion is compressed. When in use, the cushion is automatically inflated. The volume can be reduced for storage, not occupying space.

Another object of the present invention is to provide an auto-inflating cushion structure capable of being compressed, which is specially designed to support a user lying on his/her side. The cushion has a wedge shape. When it is placed behind the user for side support, it can fully meet the needs and the effect is excellent, not like the prior art that needs to adjust the shape or increase/decrease the number of pillows.

A further object of the present invention is to provide an auto-inflating cushion structure capable of being compressed, which uses the pressure difference to let the external air in when in use, in cooperation with the expansion of the inner filling body, so that the interior of the cushion is automatically inflated. It is very convenient to use.

In order to achieve the above objects, an auto-inflating cushion structure capable of being compressed is provided. The auto-inflating cushion structure comprises an outer covering and an inner filling body. The inner filling body is accommodated in the outer covering and has a three-dimensional shape in a normal state. The outer covering is provided with an air valve unit.

Preferably, the outer covering is made of an air-impermeable material in a three-dimensional bag-like configuration.

Preferably, the outer covering and the inner filling body each have a wedge shape.

Preferably, the outer covering is formed with an opening in an appropriate place.

Preferably, the opening is provided with the air valve unit.

Preferably, the inner filling body is made of a PU (polyurethane) material, but not limited to this. The inner filling body made of the PU material has a plurality of air-permeable pores for circulating the air easily.

Preferably, a filter member is provided inside the air valve unit. The filter member is configured to prevent dust and foreign matter from entering the interior of the outer covering.

Preferably, the air valve unit includes a base. A through hole is defined in the base for air circulation. A sleeve and a sleeve cover are connected to the base and located beside the base. The sleeve serves as a one-way check valve. The sleeve is inserted in the through hole. The sleeve cover is configured to cover an outside of the base for sealing the through hole.

### BRIEF DESCRIPTION OF THE DRAWINGS

FIG. 1 is a perspective view of the present invention;

FIG. 2 is an exploded view of the present invention;

FIG. 3 is a schematic view of the present invention, illustrating that the cushion is to be inflated; and

FIG. 4 is a schematic view of the present invention when in use, serving as an auxiliary support for a user lying on his/her side.

### DETAILED DESCRIPTION OF THE PREFERRED EMBODIMENTS

Embodiments of the present invention will now be described, by way of example only, with reference to the accompanying drawings.

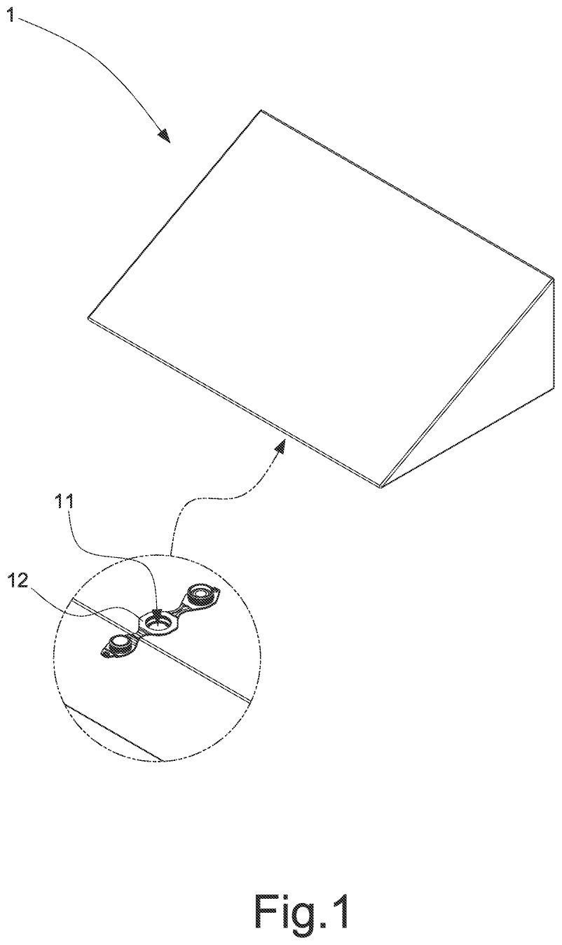

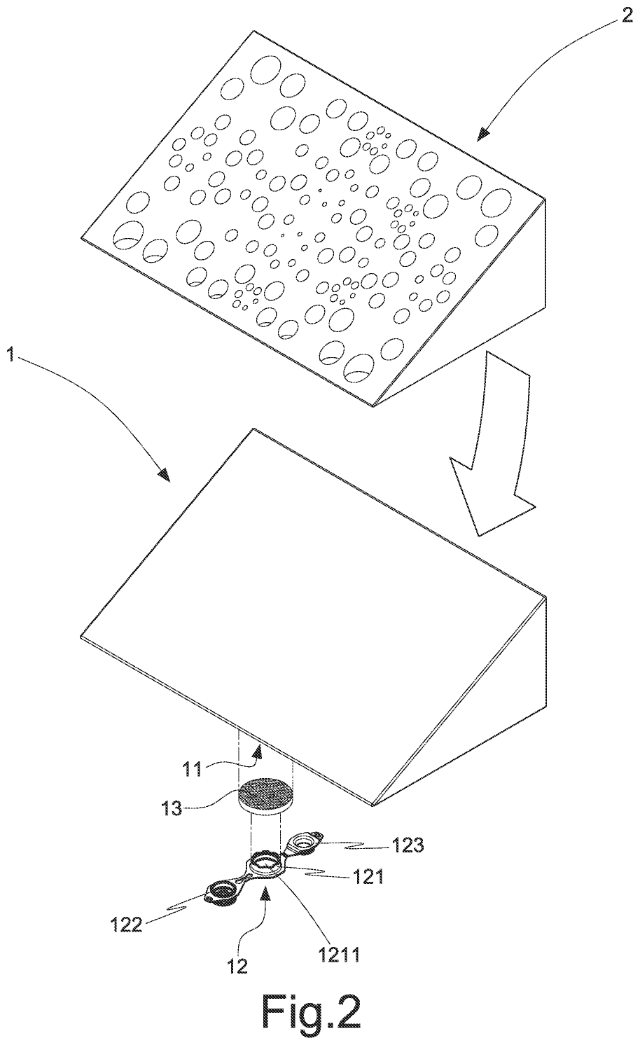

As shown in FIG. 1 and FIG. 2, an auto-inflating cushion structure capable of being compressed according to an embodiment of the present invention comprises an outer covering 1 and an inner filling body 2. The inner filling body 2 is accommodated in the outer covering 1 and has a three-dimensional shape in a normal state. The outer covering 1 is provided with an air valve unit 12. The outer covering 1 is made of an air-impermeable material in a three-dimensional bag-like configuration. Preferably, both the outer covering 1 and the inner filling body 2 are in a wedge shape. The outer covering 1 is formed with an opening 11 in an appropriate place. The opening 11 of the outer covering 1 is provided with the air valve unit 12. A filter member 13 is provided inside the air valve unit 12. The filter member 13 is configured to prevent dust and foreign matter from entering the interior of the outer covering 1. The air valve unit 12 includes a base 121. A through hole 1211 is defined in the center of the base 121 for air circulation. A sleeve 122 and a sleeve cover 123 are connected to the base 121 and located beside the base 121. The sleeve 122 serves as a one-way check valve. The sleeve 122 is inserted in the through hole 1211. The sleeve cover 123 is configured to cover the outside of the base 121 so as to seal the through hole 1211. The inner filling body 2 is preferably made of a PU (polyurethane) material, but not limited to this.

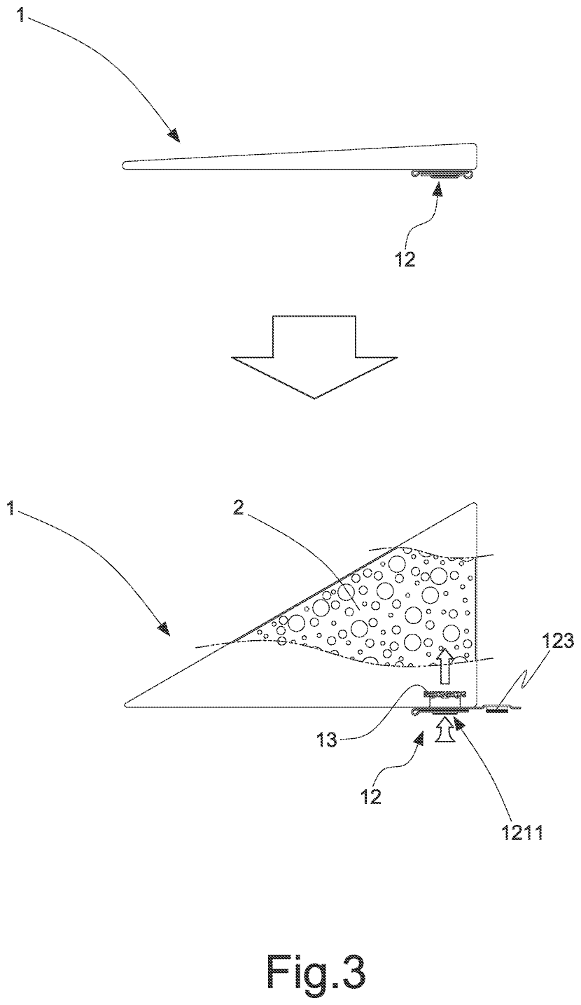

When the product of the present invention is finished, the air inside the product is almost completely discharged by applying pressure to the outside of the outer covering 1. The inner filling body 2 is compressed, and the air valve unit 12 is closed to make the entire cushion thin and compressed, as shown in the upper part of FIG. 3. It is advantageous to reduce the size and facilitate transportation, storage and sale.

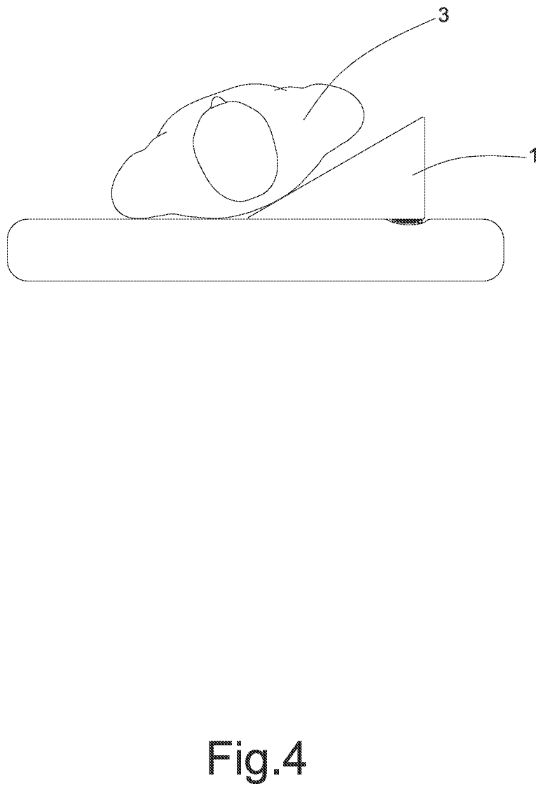

When in use, the sleeve 122 and the sleeve cover 123 are flipped outwardly to open the air valve unit 12. The pressure difference allows the external air to flow into the outer covering 1, in cooperation with the expansion of the inner filling body 2, so that the interior of the cushion is automatically inflated (as shown in the lower part of FIG. 3). After the air valve unit 12 is closed, the interior of the cushion is filled with air, like a soft airbag. When the inflated cushion is placed behind a user 3 lying on his/her side (as shown in FIG. 4), with the wedge-shaped structure, it can provide comfortable limit and auxiliary support for the user 3. When the cushion is not in use, it can be easily compressed to discharge the air so as to become thinner. The cushion can be stored with ease, and is very ideal and practical.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An auto-inflating cushion structure, comprising an outer covering and an inner filling body, the outer covering being formed with an opening, the opening being provided with an air valve unit; the inner filling body being accommodated in the outer covering and having a three-dimensional shape in a normal state.

2. The auto-inflating cushion structure as claimed in claim 1, wherein the outer covering is made of an air-impermeable material in a three-dimensional bag-like configuration.

3. The auto-inflating cushion structure as claimed in claim 1, wherein the outer covering and the inner filling body each have a wedge shape.

4. The auto-inflating cushion structure as claimed in claim 3, wherein the inner filling body is made of a PU (polyurethane) material.

5. The auto-inflating cushion structure as claimed in claim 1, wherein a filter member is provided inside the air valve unit.

6. The auto-inflating cushion structure as claimed in claim 1, wherein the air valve unit includes a base, a through hole is defined in the base for air circulation; a sleeve and a sleeve cover are connected to the base and located beside the base.

7. The auto-inflating cushion structure as claimed in claim 6, wherein the sleeve serves as a one-way check valve, the sleeve is inserted in the through hole; the sleeve cover is configured to cover an outside of the base.
